(19) United States
(12) Patent Application Publication
(10) Pub. No.: US 2003/0085883 A1
(43) Pub. Date: May 8, 2003

(54) Selector pen for touch screen

(76) Inventor: Mao-Sung Wu, Taoyuan (TW)

Correspondence Address: BIRCH STEWART KOLASCH & BIRCH, PO BOX 747, FALLS CHURCH, VA, 22040-0747, US

(21) Appl. No.: 09/986,098

(22) Filed: Nov. 7, 2001

(51) Int. Cl. G09G 5/00

(52) U.S. Cl. 345/179

(57) ABSTRACT

A selector pen for touch screen includes a barrel, a light emitter mounted in the barrel, a switch connected to a rear end of the barrel for turning on or off the light emitter, and a transparent head connected to a front end of the barrel. When a user needs to use a touch screen in a dim environment, he or she may operate the switch for the light emitter to emit light that passes through the transparent head to illuminate a space surrounding the selector pen and thereby enables the user to easily select function options on the touch screen with the selector pen.

### BACKGROUND OF THE INVENTION

The present invention relates to a selector pen, and more particularly to a selector pen provided with light-emitting means that could be turned on to emit light and illuminate a dim environment for a user to select function options on a touch screen with the selector pen.

With the highly advanced computer technology, various kinds of electronic products have been developed to have compact volume and increased functions. For example, there are many computerized products having key-controlled functions directly provided on a screen to largely reduce the volume of the products. The screen is provided with a sensing membrane via which user's instructions are entered. Such screen is referred to as a touch screen and has been developed for both a big-size screen for general computers and a small-size liquid crystal display (LCD) for electronic dictionary, personal digital assistant (PDA) , etc. To enter instructions or to select options on the touch screen, a selector pen (that is, a light pen) is usually needed to touch the screen, though the instructions and the selections may also be entered by handwriting.

A problem in using the LCD is that the LCD is not an illuminant or is only provided with a very weak auxiliary light. Thus, the LCD is preferably used at a sufficiently light environment to enable clearly visible images for subsequent selection on the screen. In the event the LCD is used in a dim environment, it would be very difficult to correctly enter the instruction or select a function on the touch screen. In other words, electronic products with LCD would become completely useless in a not sufficiently illuminated environment.

It is therefore tried by the inventor to develop a selector pen with light-emitting means to solve the problem of using a touch screen in a dim environment.

### SUMMARY OF THE INVENTION

A primary object of the present invention is to provide a selector pen capable of emitting light to illuminate a space surrounding the selector pen and thereby facilitates operation on a touch screen with the selector pen even in a dim environment.

To achieve the above and other objects, the selector pen for touch screen according to the present invention mainly includes a barrel, a light-emitting means mounted in the barrel, a switch connected to a rear end of the barrel for turning on or off the light-emitting means, and a transparent head connected to a front end of the barrel. When a user needs to use a touch screen in a dim environment, he or she may operate the switch of the selector pen for the light-emitting means to emit light that passes through the transparent head to illuminate a space surrounding the selector pen and thereby enables the user to easily select function options on the touch screen with the selector pen.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an exploded perspective view of a selector pen for touch screen according to the present invention;

FIG. 2 is block diagram of a voltage booster circuit for the selector pen of the present invention;

FIG. 3 is an assembled sectional view of the selector pen of the present invention before being electrically made to emit light;

FIG. 4 is an assembled sectional view of the selector pen of the present invention having been electrically made to emit light; and

FIG. 5 shows an example of usage of the selector pen of the present invention by attaching it to a personal digital assistant.

### DETAILED DESCRIPTION OF THE PREFERRED EMBODIMENTS

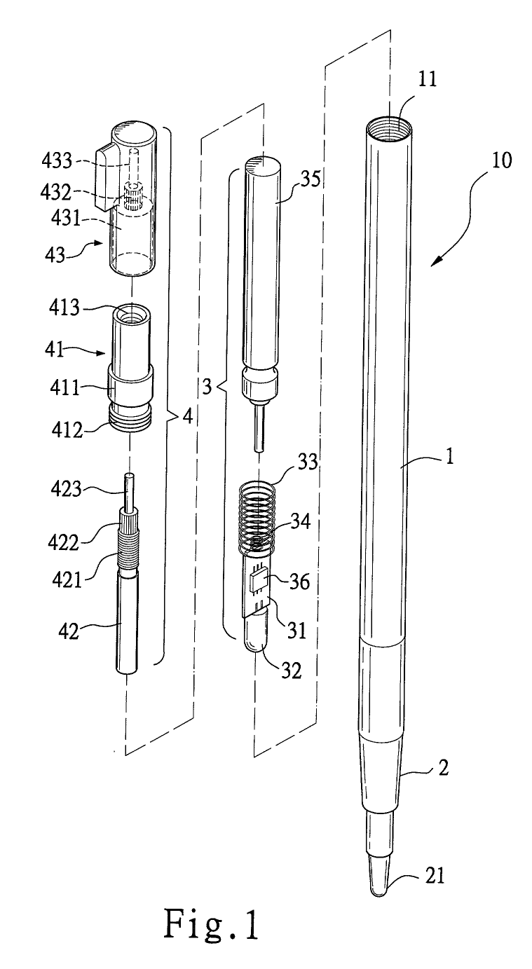

Please refer to FIG. 1 that is an exploded perspective view of a selector pen 10 according to the present invention. As shown, the selector pen 10 mainly includes a barrel 1, a transparent head 2, a light-emitting means 3, and a switch 4.

The barrel 1 is a hollow tube with the transparent head 2 fixedly connected to a front end thereof and the light-emitting means 3 mounted therein. A rear end of the barrel 1 is provided with an internal screw thread 11 for the switch 4 to screw thereinto.

The transparent head 2 is a substantially conic body having a blunt front point 21 and allows light emitted from the light-emitting means 3 inside the barrel 1 to pass therethrough.

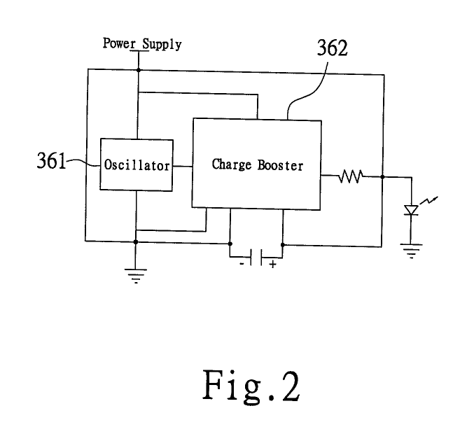

The light-emitting means 3 includes a circuit board 31 having a light emitter 32, which is preferably a light emitting diode, connected thereto; a big spring 33 connected to a positive electrode of a power input of the circuit board 31; a small spring 34 connected to a negative electrode located at a center in the big spring 33; and a battery 35 having a front outer peripheral surface forming a positive electrode to contact with the big spring 33 and a bar-shaped negative electrode forward projected from a center of the positive electrode to extend into the big spring 33 for contacting with the small spring 34. When a special light emitting diode is used, such as a white light emitting diode that needs a voltage higher than that for general light emitting diodes, the circuit board 31 is additionally provided with a voltage booster circuit 36, as shown in FIG. 2. An oscillator 361 and a charge booster 362 on the voltage booster circuit 36 are used to increase the voltage, so that the voltage rises from low to high voltage to provide the special light emitting diode with normal working voltage.

The switch 4 includes a fixing seat 41, a movable rod 42, and a cap 43. The fixing seat 41 is a hollow tube generally divided into a lower half and an upper half. An upper outer periphery of the lower half is provided with a collar 411 having an outer diameter corresponding to that of the barrel 1, and a lower outer periphery of the lower half below the collar 411 is provided with an external screw thread 412 for engaging with the internal screw thread 11 of the barrel 1. The upper half of the fixing seat 41 is provided at an inner upper end with an internal screw thread 413. The movable rod 42 is provided around a lower portion of an upper half with an external screw thread 421 corresponding to the internal screw thread 413 of the fixing seat 41, immediately above the external screw thread 421 with a diameter-reduced gear 422, and above the gear 422 with a shaft 423. The cap 43 has an open end communicable with a stepped internal space defined by the cap 43. The stepped internal space of the cap 43 includes a first recess 431 most close to the opening end for receiving the fixing seat 41 and the movable rod 42, a second recess behind the first recess for receiving the gear 432, and a third recess behind the second recess for receiving the shaft 433.

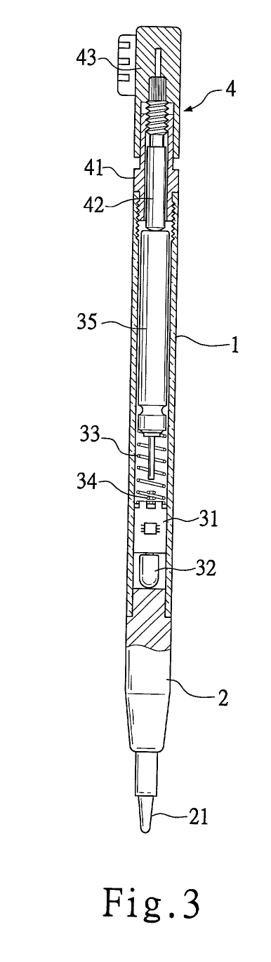

Please refer to FIG. 3 that is an assembled sectional view of the selector pen of the present invention. When the light-emitting means 3 is mounted in the barrel 1, the light emitter 32 is caused to face forward and contact with the transparent point 2, and the big and the small springs 33, 34 are located behind the light emitter 32 to correspond to the positive and the negative electrodes, respectively, of the battery 35. Due to a spring force applied by the big spring 33 on the battery 35 to push the latter backward, the small spring 34 is normally prevented from electrically contacting with the bar-shaped negative electrode of the battery 35. The switch 4 is mounted to the rear end of the barrel 1 by engaging the external screw thread 412 of the fixing seat 41 with the internal screw thread 11 of the barrel 1, so that a free end of the movable rod 42 is normally in contact with a rear end surface of the battery 35.

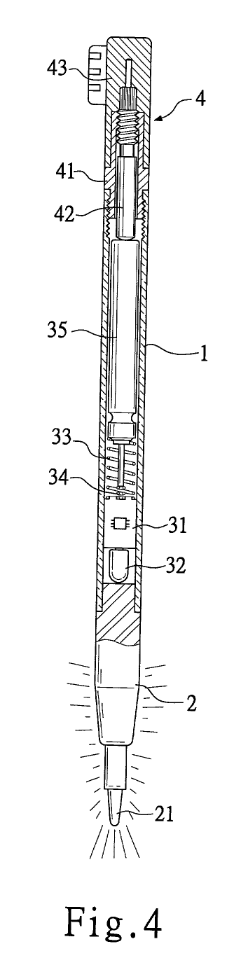

To use the selector pen 10 of the present invention, simply turn the cap 43 in a predetermined direction, so that the gear 422 received in the second recess 432 of the cap 43 is brought to rotate. At this point, the external screw thread 421 of the movable rod 42 is guided by the internal screw thread 413 of the fixing seat 41 to move forward, bringing the movable rod 42 to push against the battery 35 and accordingly compress the big spring 33. At this point, the bar-shaped negative electrode of the battery 35 is gradually moved forward to eventually contact the small spring 34 to make the light emitter 32 for the latter to emit light which passes through the transparent head 2 to illuminate a space surrounding the selector pen 10, as shown in FIG. 4. When the switch 4 is turned reversely, the movable rod 42 is brought to move backward and the light emitter 32 is turned off, accordingly, as shown in FIG. 3.

It is understood the switch 4 is not necessarily controlled by way of screw threads. It is also possible to provide a push switch to turn the light emitter 32 on or off.

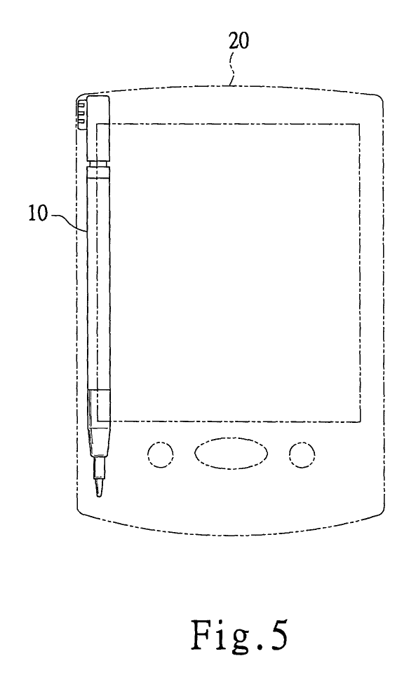

The selector pen 10 may be conveniently attached to, for example, a personal digital assistant (PDA) by positioning it in a groove provided at one side of the PDA, as shown in FIG. 5. When a user needs to use the PDA in a dim environment, he or she may switch on the selector pen 10 for the light emitter 32 to emit light and illuminate the PDA, enabling selection of function options on a touch screen of the PDA with the front end 21 of the selector pen 10.

The present invention has been described with a preferred embodiment thereof and it is understood that many changes and modifications in the described embodiment can be carried out without departing from the scope and the spirit of the invention that is intended to be limited only by the appended claims.

What is claimed is:

1. A selector pen for touch screen, comprising a barrel, a light-emitting means mounted in said barrel, a switch connected to a rear end of said barrel for turning on or off said light-emitting means, and a transparent head connected to a front end of said barrel, whereby light emitted from said light-emitting means passes through said transparent head to illuminate a space surrounding said selector pen.

2. The selector pen for touch screen as claimed in claim 1, wherein said switch is a turn switch.

3. The selector pen for touch screen as claimed in claim 1, wherein said switch is a push switch.

4. The selector pen for touch screen as claimed in claim 1, wherein said light-emitting means includes a circuit board and a battery.

5. The selector pen for touch screen as claimed in claim 4, wherein said circuit board is provided at an end with means for electrically connecting said circuit board to positive and negative electrodes of said battery, and at another end with a light-emitting diode.

6. The selector pen for touch screen as claimed in claim 4, wherein said circuit board includes a voltage booster circuit to enable stable emission of light from a special light-emitting diode.

7. The selector pen for touch screen as claimed in claim 5, wherein said means for electrically connecting said circuit board to said battery include a big and a small spring connectable to said positive and said negative electrodes, respectively, of said battery.
